(19) United States
(12) Patent Application Publication
(10) Pub. No.: US 2025/0258540 A1
(43) Pub. Date: Aug. 14, 2025

(54) Systems and Methods for Implementing Contextual Cookies

(71) Applicant: Verizon Patent and Licensing Inc., Basking Ridge, NJ (US)

(72) Inventors: Viraj C. Mantri, Hyderabad (IN); Abhishek Shukla, Jabalpur MP (IN); Srividhya Parthasarathy, Chennai (IN); Kedar Phadke, Hyderabad (IN); Kanakasubramaniam Krishnamurthi, Chennai (IN)

(21) Appl. No.: 18/437,324

(22) Filed: Feb. 9, 2024

(51) Int. Cl. G06F 3/01; G06F 9/451

(52) U.S. Cl. CPC G06F 3/013; G06F 3/012; G06F 9/451

(57) ABSTRACT

An illustrative system includes a memory that stores instructions and a processor communicatively coupled to the memory and configured to execute the instructions to perform a process. The process may comprise tracking engagement information of a user while the user views user interface content, determining, based on the engagement information, a gaze point of the user with respect to the user interface content, mapping the gaze point of the user to a user interface element associated with the user interface content, and dynamically generating or updating, based on the engagement information and the mapping of the gaze point of the user to the user interface element, a contextual cookie that is configured to store user intent information associated with the user's engagement with the user interface content.

### BACKGROUND INFORMATION

As computer technology has advanced, various tools have been developed to facilitate entities providing content based on users' interactions with websites assessed by way of computer systems. For example, websites typically use cookies, which are small data blocks that store information about user preferences and/or interactions with websites. The stored information may be accessed and used to make user visits to websites easier, more intuitive, and/or more convenient for the users.

Typically, front-end code dictates, for example, when a cookie may be generated, what data may be stored as part of the cookie, and when or whether the cookie expires. Thus, to change such parameters of cookies, changes in the front-end code and deployment are required. In view of this, there remains room for improvement in implementing cookies used by domains, websites, etc.

### BRIEF DESCRIPTION OF THE DRAWINGS

The accompanying drawings illustrate various embodiments and are a part of the specification. The illustrated embodiments are merely examples and do not limit the scope of the disclosure. Throughout the drawings, identical or similar reference numbers designate identical or similar elements.

FIG. 1 shows an illustrative contextual cookie management system according to principles described herein.

FIG. 2 shows an illustrative implementation of the contextual cookie management system of FIG. 1 according to principles described herein.

FIGS. 3-4 show illustrative flow diagrams depicting various operations that may be performed according to principles described herein.

FIG. 5 shows an illustrative data set that may be tracked and stored as engagement information according to principles described herein.

FIG. 6 shows an illustrative configuration of clusters that may be implemented according to principles described herein.

FIG. 7 shows an illustrative method for implementing contextual cookies according to principles described herein.

FIG. 8 shows an illustrative computing device according to principles described herein.

### DETAILED DESCRIPTION OF EXAMPLE EMBODIMENTS

Systems and methods for implementing contextual cookies are described herein. In certain examples, a system may comprise a memory that stores instructions and a processor communicatively coupled to the memory and configured to execute the instructions to perform a process. The process may comprise tracking engagement information of a user while the user views user interface content, determining, based on the engagement information, a gaze point of the user with respect to the user interface content, mapping the gaze point of the user to a user interface element associated with the user interface content, and dynamically generating or updating, based on the engagement information and the mapping of the gaze point of the user to the user interface element, a contextual cookie that is configured to store user intent information associated with the user's engagement with the user interface content.

As used herein, a “contextual cookie” may include any suitable data instance or data block that may be generated based at least in part on gaze information (e.g., gaze dwell time, eye gaze information, facial expression information, etc.) of a user with respect to user interface content and that may store information associated with the user's engagement with, interest in, and/or intent with respect to the user interface content. In contrast, conventional cookies do not take into consideration such gaze information to assess user intent/interest. Moreover, in further contrast to conventional cookies, contextual cookies such as those described herein are not generated rigidly based on front-end code that dictates when to generate a cookie, what interaction triggers the generation of a cookie, what information to include in the cookie, what specific interactions map directly to what information is included in the cookie, etc. Rather, contextual cookies such as those described herein may be dynamically generated or updated in real time based at least in part on gaze information of a user with respect to any possible user interface element or combination of user interface elements that may be presented as part of user interface content. As such, the specific information or type of information that may be stored in contextual cookies such as those described herein is not predetermined by rigid, predefined logic and may change and/or be automatically updated based on user engagement and/or the context in which the user interface content is viewed. Moreover, as will be described further herein, systems and methods may leverage any suitable machine learning algorithm(s) to automatically determine where a user is looking with respect to user interface content and/or whether the user is interested or disinterested in the user interface content to facilitate implementing contextual cookies. Additionally or alternatively, in some embodiments, any suitable machine learning algorithm(s) may be used to determine user intent and/or interest information to store in a contextual cookie based at least in part on gaze information of a user with respect to any possible user interface element or combination of user interface elements that may be presented as part of user interface content.

Various advantages and benefits are associated with the systems and methods for implementing contextual cookies described herein. For example, systems and methods such as those described herein may facilitate automatically and dynamically generating or updating contextual cookies that include information indicative of user intents and/or interests as they engage with user interface content. This dynamic generation of contextual cookies may provide useful insights regarding user consumption of user interface content and/or facilitate providing individualized content to users. For example, contextual cookies such as those described herein may provide information regarding pain points that users may experience while viewing user interface content. Further, contextual cookies such as those described herein may be configured to be shared across domains and sub domains for user tracking and/or user intent tracking purposes. These and other benefits that may be provided by systems and methods such as those described herein will be evident from the disclosure that follows.

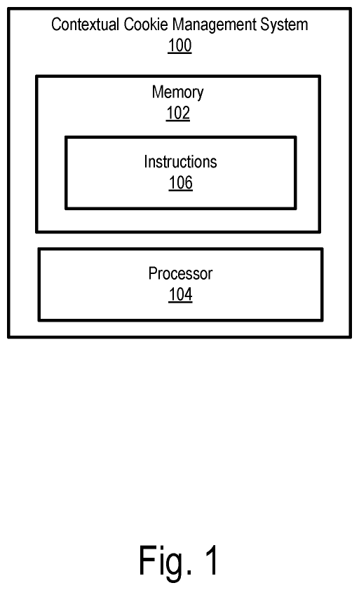

FIG. 1 shows an illustrative contextual cookie management system 100 (“system 100”) that may be implemented according to principles described herein. As shown, system 100 may include, without limitation, a memory 102 and a processor 104 selectively and communicatively coupled to one another. Memory 102 and processor 104 may each include or be implemented by hardware and/or software components (e.g., processors, memories, communication interfaces, instructions stored in memory for execution by the processors, etc.). In some examples, memory 102 and/or processor 104 may be implemented by any suitable computing device. In other examples, memory 102 and/or processor 104 may be distributed between multiple devices and/or multiple locations as may serve a particular implementation. Illustrative implementations of system 100 are described herein.

Memory 102 may maintain (e.g., store) executable data used by processor 104 to perform any of the operations described herein. For example, memory 102 may store instructions 106 that may be executed by processor 104 to perform any of the operations described herein. Instructions 106 may be implemented by any suitable application, software, code, and/or other executable data instance.

Memory 102 may also maintain any data received, generated, managed, used, and/or transmitted by processor 104. Memory 102 may store any other suitable data as may serve a particular implementation. For example, memory 102 may store any suitable data associated with user engagement with user interface content and/or generating a contextual cookie including domain tree structure information (e.g., indicating size, position, shape, color, etc. of domain elements), motion parameter for videos, biometric information (e.g., eye gaze information, eye state information (open, closed, etc.), eye expression information, face expression information, time of gaze, heart rate information, etc.), user intent information, settings information, graphical user interface content, and/or any other suitable data.

Processor 104 may be configured to perform (e.g., execute instructions 106 stored in memory 102 to perform) various processing operations associated with implementing contextual cookies. For example, processor 104 may perform one or more operations described herein to dynamically and automatically generate one or more contextual cookies. As used herein, the expression “automatically” means that an operation (e.g., an operation of tracking engagement information) or series of operations are performed without requiring further input from a user. For example, a determination that a user is gazing at a particular user interface element may trigger automatic generation of a contextual cookie associated with that user interface element without requiring further input from the user or any additional user (e.g., a developer). These and other operations that may be performed by processor 104 are described herein.

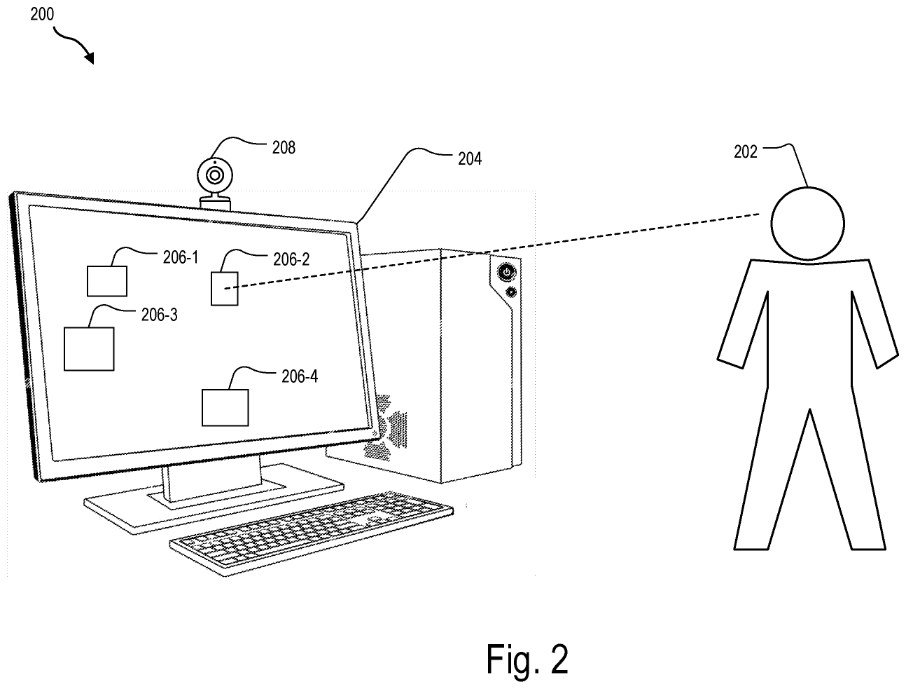

System 100 may be implemented in any suitable manner. FIG. 2 shows an illustrative implementation 200 in which system 100 may be provided in certain examples. As shown in FIG. 2, a user 202 may interact with user interface content displayed by a display screen 204 of a desktop computer. The user interface content may correspond to any content that a user may view, hear, or otherwise experience by way of a computing device such as the desktop computer shown in FIG. 2. For example, the user interface content may correspond to one of a plurality of web pages associated with a common domain name accessible by way of a web server. In the example shown in FIG. 2, the user interface content includes one or more user interface elements 206 (e.g., user interface elements 206-1 through 206-4) that user 202 may selectively look at and/or engage with while viewing the user interface content. User interface elements 206 may correspond to any type of element that may be represented within or together with user interface content. For example, user interface elements 206 may include text, videos, sounds, still images, advertisements, user interface elements (e.g., buttons, icons, etc.), and/or any other suitable content that may be represented in or together with user interface content.

Although implementation 200 shown in FIG. 2 depicts a desktop computer, it is understood that any other suitable type of computing device may be used to provide user interface content, receive user input, and/or facilitate dynamically generating contextual cookies as may serve a particular implementation. For example, a smartphone, a tablet computer, a laptop computer, a gaming device, a virtual reality device, an augmented reality device, a smart TV, and/or any other suitable device may be used to facilitate tracking engagement information and/or implementing contextual cookies such as those described herein.

To facilitate dynamically generating or updating contextual cookies, system 100 may be configured to track engagement information of a user while the user views and/or otherwise interacts with user interface content. As used herein, “engagement information” may include any suitable information associated with user interface content and/or a user's interaction and/or interest (or lack thereof) with respect to the user interface content. For example, engagement information may include biometric information and/or any other suitable information. Biometric information may include eye gaze information such as eye gaze position information indicative of where the user is looking with respect to the user interface content. In certain examples, the biometric information may further include at least one of eye attribute information, heart rate information, or facial expression information. For example, engagement information may include facial landmark information (e.g., eyes, irises, pupils, etc.) and/or their attributes (e.g., whether they are open, closed, shrunk, dilated, etc.), dwell time with respect to the user interface content, and/or any other suitable information.

System 100 may track engagement information in any suitable manner. For example, system 100 may access image data captured by an imaging device positioned in front of a user. To illustrate, in the example shown in FIG. 2, a camera 208 is communicatively coupled to the desktop computer and configured to capture images of the face of user 202 while user 202 views the user interface content displayed by display screen 204.

In certain examples, system 100 may process image data to identify at least some of the engagement information. This may be accomplished in any suitable manner. For example, system 100 may access a live feed of image frames captured by camera 208. System 100 may process the image frames in any suitable manner (e.g., using a MediaPipe model and/or a TensorFlow model) to identify positions (e.g., x, y positions) of eyes, pupils, irises, their state and/or other features such as whether they eyes are open or closed and/or whether the pupils are shrunk, dilated, etc. at each of a plurality of time points.

In certain examples, system 100 may execute any suitable machine learning algorithm to process engagement information and/or any other suitable information associated with contextual cookies. For example, system 100 may implement any suitable supervised or unsupervised machine learning algorithm such as a k-means machine learning algorithm in certain implementations.

Based on the engagement information, system 100 may determine a gaze point of user 202 with respect to the user interface content. This may be accomplished in any suitable manner using any suitable gaze tracking method. For example, system 100 may implement a mid-point algorithm to obtain a common viewpoint for each eye and use ray-cast logic to identify the x, y coordinates on display screen 204. System 100 may then determine the gaze point of the user based on the common viewpoint and the x, y coordinates on display screen 204. In certain examples, system 100 may determine the depth (z) of the gaze point and the direction of the head of the user and use that information to calibrate gaze points for accuracy.

After system 100 determines the gaze point of the user, system 100 may map the gaze point to a user interface element associated with the user interface content. This may be accomplished in any suitable manner. For example, system 100 may access a domain tree structure from the browser to determine information associated with one or more user interface elements represented in the user interface content. Such information may indicate where a user interface element is positioned, the size of the user interface element, the shape of the user interface element, the type of the user interface element, the content of the user interface element, and/or any other information associated with the user interface element. Based on the information provided by the domain tree structure, system 100 may determine that the gaze point of the user is associated with a particular user interface element if, for example, the x, y coordinates of the gaze point overlap or are within a predefined threshold distance from an area occupied by the particular user interface element within the user interface content. For example, system 100 may determine, based on the gaze point and the information from the domain tree structure, that the gaze point is at an x, y position on display screen 204 that corresponds to a position of user interface element 206-2. In view of this, system 100 may determine that user 202 is looking at user interface element 206-2 and may map the gaze point of user 202 to user interface element 206-2.

Based on the engagement information and the mapping of the gaze point of the user to the user interface element, system 100 may dynamically generate or update one or more contextual cookies.

Contextual cookies such as those described herein may be generated in any suitable manner and may store any suitable information. For example, in certain implementations, contextual cookies may store user intent information associated with a user's engagement with user interface content. Such user intent information may include any suitable information indicative of a user's interest or disinterest in the user interface content (e.g., in one or more elements of the user interface content). To that end, in certain examples, the dynamically generating of a contextual cookie may include system 100 determining, based on engagement information, an intent of a user with respect to the user interface content. This may be accomplished in any suitable manner. For example, system 100 may determine based on the gaze of the user dwelling on user interface element 206-2 for a threshold amount of time that user 202 is interested in the content associated with user interface element 206-2 and/or that user 202 intends to interact with user interface element 206-2. System 100 may store the intent of the user as part of user intent information of the contextual cookie.

In certain examples, the dynamically generating of a contextual cookie may include generating a plurality of behavior vectors based on the engagement information. System 100 may generate any suitable number of behavior vectors as may serve a particular implementation. For example, system 100 may generate a first behavior vector, a second behavior vector, a third behavior vector, a fourth behavior vector, and so forth.

In such examples, system 100 may cluster the plurality of behavior vectors into a plurality of clusters. This may be accomplished in any suitable manner. For example, system 100 may cluster the first behavior vector and the second behavior vector into a first cluster and the third behavior vector and the fourth behavior vector into a second cluster. Examples of clustering are described herein.

After system 100 clusters the behavior vectors, system 100 may classify the plurality of clusters. This may be accomplished in any suitable manner. For example, system 100 may analyze the engagement information included in each of the clusters to determine the type of engagement and/or any other suitable information associated with the engagement. System 100 may use any suitable number of classifications and any suitable types of classification as may serve a particular implementation. For example, a first classification may correspond to an interested classification, a second classification may correspond to a disinterested classification, a third classification may correspond to a rage view classification, etc. Examples of such classifications are described herein.

Based on the classifying of the plurality of clusters, system 100 may predict an intent of the user with respect to the user interface content. For example, system 100 may predict that the user is interested in the user interface element associated with the second cluster and/or may predict that the user is not interested in the user interface element associated with the first cluster. System 100 may store the intent of the user in any suitable manner as part of the user intent information of the contextual cookie.

System 100 may store the user intent information of a contextual cookie in any suitable manner and in any format. In certain examples, the user intent information of a contextual cookie may include a first name-value pair that includes information indicating an intent of a user with respect to user interface content and a second name-value pair that includes information indicating an ignored portion of the user interface content. To illustrate an example, a contextual cookie may include a first name-value pair that identifies the make and model of a first car and provides a first numerical value indicating that the user has a relatively high level of interest in the first car. The contextual cookie may also include a second name-value pair that identifies the make and model of a second car and that provides a second numerical value indicating that the user has a relatively low level of interest in the second car. In such an example, system 100 may generate the contextual cookie based on the user's gaze dwelling on images of the first car relatively longer than on images of the second car while viewing an advertisement from a car dealership.

In certain examples, system 100 may be configured to continually or periodically track engagement information while a user views user interface content and to determine a plurality of different gaze points of the user with respect to the user interface content. In certain examples, the plurality of different gaze points may be indicative of an engagement sequence associated with content that may be of interest to the user. For example, system 100 may determine, based on engagement information, an additional gaze point of the user with respect to the user interface content. System 100 may map the additional gaze point of the user to an additional user interface element associated with the user interface content. Based on the mapping of the additional gaze point to the additional user interface element, system 100 may determine an engagement sequence of the user with respect to the user interface element and the additional user interface element. In such examples, the dynamically generating of the contextual cookie may include system 100 determining, based on the engagement sequence, an intent of the user with respect to the user interface element and the additional user interface element.

Contextual cookies such as those described herein may be used in any suitable manner as may serve a particular implementation. In certain examples, contextual cookies may be configured to be used across different domains and different subdomains to track engagement of the user with respect to different user interface content. For example, a contextual cookie may be configured to be used while a user accesses a first domain (e.g., a first webpage) and/or one or more subdomains associated with the first domain. The contextual cookie may also be configured to be used while a user accesses a second domain (e.g., a second webpage) that is different than the first domain. The contextual cookie may also be configured to be used while the user accesses one or more subdomains associated with the second domain.

Contextual cookies may be configured in any suitable manner to be used across different domains or subdomains. For example, in certain implementations, a contextual cookie may include or otherwise be associated with a permissions list that identifies each domain and/or subdomain where the contextual cookie may be used. Such a permissions list may be defined during cookie generation and may be updated automatically and/or manually based on user input. In certain examples, user input may be required to authorize the domains/subdomains included in the permissions list.

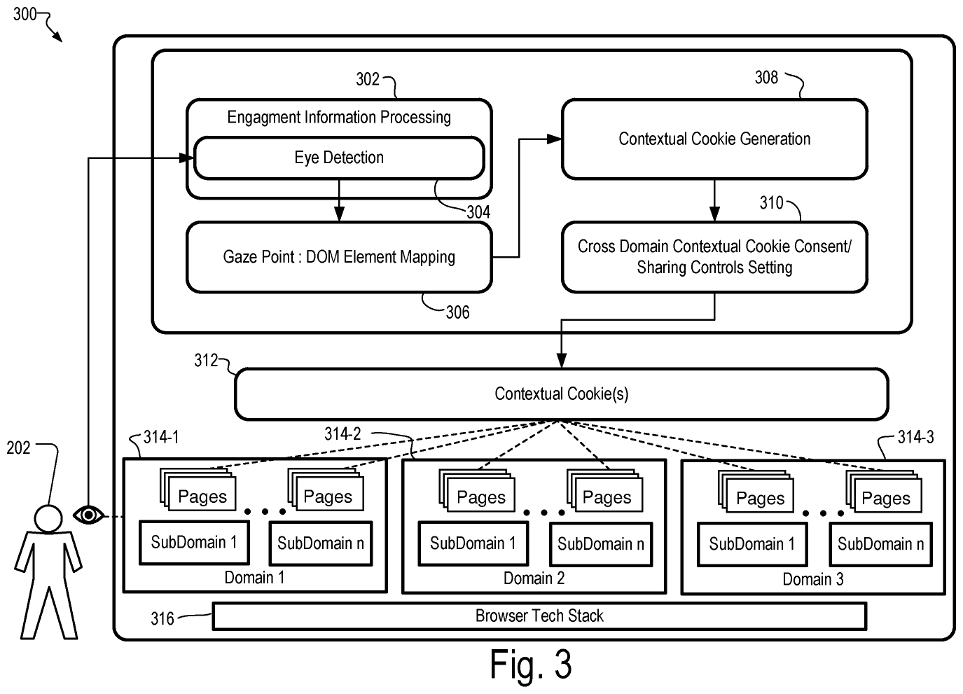

Additionally or alternatively, contextual cookies may be provided in a particular format that facilitates cross domain/subdomain use and/or sharing. For example, the format of a contextual cookie having a first name-value pair and a second name-value pair in the example described above may facilitate the contextual cookie being usable across various domains and/or subdomains. FIG. 3 depicts an illustrative flow diagram 300 showing various operations that may be performed by system 100 in implementing contextual cookies such as those described herein. As shown in FIG. 3, system 100 may perform engagement information processing at operation 302 to track engagement information while user 202 views user interface content. Based on the engagement information, system 100 may perform eye detection at operation 304 in any suitable manner. For example, system 100 may determine the x, y coordinates of the iris of the left eye of user 202 and the x, y coordinates of the iris of the right eye of user 202. System 100 may use such information in any suitable manner such as described herein to determine the gaze point of user 202.

At operation 306, system 100 may map a gaze point of user 202 to a domain element in any suitable manner such as described herein. For example, system 100 may determine, based on a domain tree structure accessed from a browser, that the x, y coordinates of a gaze point overlap with an area in user interface content where an image is located. Accordingly, system 100 may map the gaze point of the user to the image.

At operation 308, system 100 may automatically generate one or more contextual cookies in any suitable manner such as described herein.

At operation 310, system 100 may update one or more cookie sharing settings that define cross domain consent and/or sharing controls for how the contextual cookies may be shared and/or used. The cookie sharing settings may be updated in such a way that a same domain, subdomains, and/or cross domains may read and write the contextual cookies, thereby ensuring that the contextual cookies carry the latest and most relevant information specific to the user's browsing behavior. In such examples, the contextual cookies may be written in a format that is readable and understandable across multiple different domains, subdomains, pages, etc.

At operation 312, system 100 may store one or more contextual cookies in a browser such that the one or more contextual cookies are available for use across different domains 314 (e.g., domains 314-1 through 314-3), their respective subdomains, and/or pages accessible by way of a browser tech stack 316.

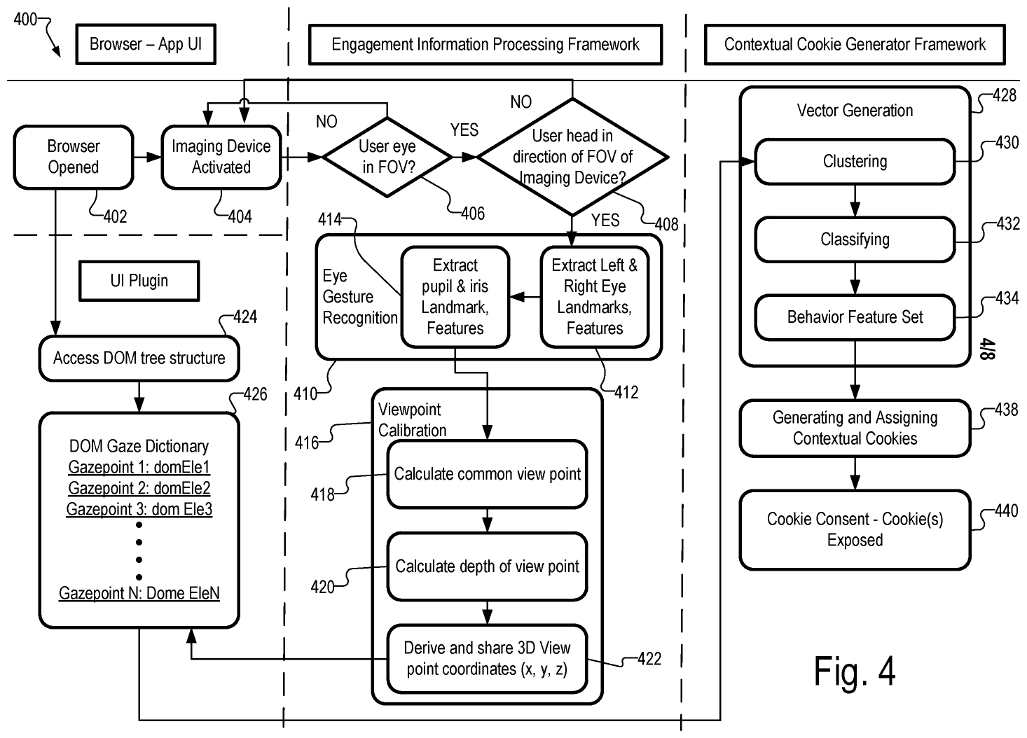

FIG. 4 shows an additional flow diagram 400 depicting various operations that may be performed by system 100 in implementing contextual cookies. As shown in FIG. 4, various different operations may be performed by a browser-app user interface (UI), a UI plugin, an engagement information processing framework, and a contextual cookie generator framework that may each be implemented either fully or partly by system 100.

As shown in FIG. 4, a browser may be opened at operation 402 and an imaging device (e.g., camera 208) may be activated at operation 404. For example, any suitable web browser (e.g., GOOGLE CHROME, FIREFOX, etc.) may be opened by a user. While the web browser is open, the user may view one or more user interface elements displayed in user interface content.

At operation 406, system 100 may determine whether an eye of the user is in a field of view (FOV) of the imaging device. If the answer at operation 406 is “NO,” the flow may return to operation 404. If the answer at operation 406 is “YES,” the flow may proceed to operation 408 where system 100 determines whether the head of the user is in the direction of the FOV of the imaging device. If the answer at operation 408 is “NO” (e.g., a side view of the eye is in the FOV of the imaging device, but the user is not looking towards the imaging device) the flow may return to operation 404. If the answer at operation 408 is “YES,” the flow may proceed to operation 410 where system 100 performs an eye gesture recognition process. The eye gesture recognition process may include system 100 accessing one or more live images of the face of a user captured by the imaging device. System 100 may extract left and right eye landmarks and/or other features at operation 412 from the images captured by the imaging device. The eye gesture recognition process may further include system 100 extracting pupil and iris landmarks and/or features at operation 414 from the landmarks and/or features extracted at operation 412.

At operation 416, system 100 may perform a viewpoint calibration process. The viewpoint calibration process may include system 100 calculating a common viewpoint at operation 418, calculating a depth of viewpoint at operation 420, and deriving and sharing 3D viewpoint coordinates (x, y, z) at operation 422.

At operation 424, system 100 may access a domain tree structure of the browser from the browser-app UI. The domain tree structure may be accessed in any suitable manner. For example, front-end code exposed by the browser may be accessible by system 100 to determine the domain tree structure of an entire webpage currently viewed by a user.

Based on the domain tree structure accessed at operation 424 and the 3D viewpoint coordinates derived at operation 422, system 100 may generate a domain gaze dictionary at operation 426. The domain gaze dictionary may include information that maps a plurality of gaze points to a plurality of domain elements. For example, in FIG. 4, a gaze point 1 is mapped to a first domain element “domEle1,” a gaze point 2 is mapped to a second domain element “domEle2,” a third gaze point 3 is mapped to a third domain element “domEle3,” and so forth. The domain gaze dictionary may include any suitable other features that may facilitate implementing a contextual cookie.

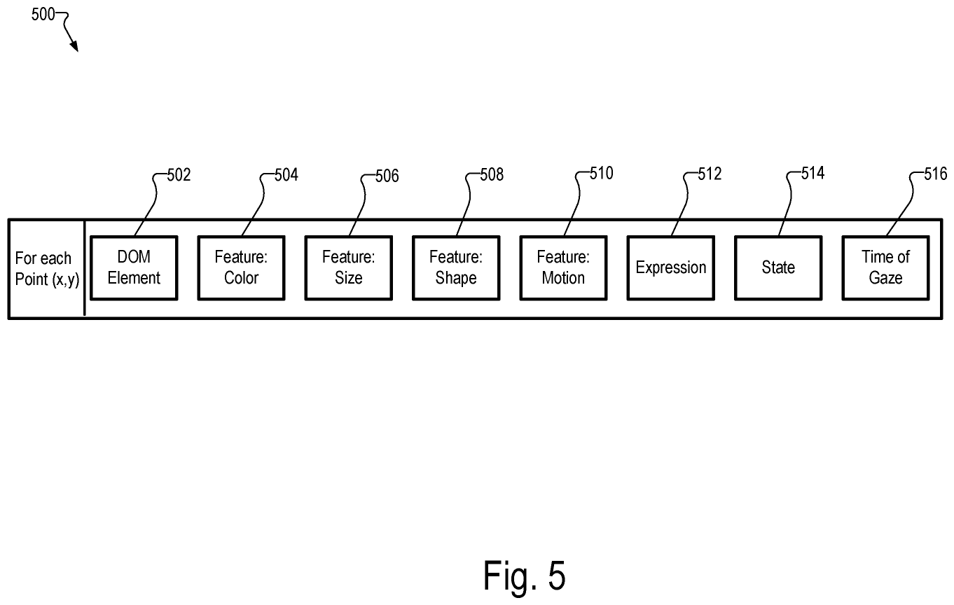

FIG. 5 shows an exemplary data set 500 that may be derived from the UI plugin and may be included as part of the domain gaze dictionary or may otherwise be used to implement contextual cookies. As shown in FIG. 5, for each point (x, y) of user interface content presented to a user, system 100 may store domain (DOM) element information 502 identifying a DOM element (also referred to herein as a user interface element) and/or the content represented by the DOM element (e.g., a button, an icon, text, etc.), color information 504 indicating a color (e.g., black, red, blue, etc.) of the DOM element, size information 506 indicating of a size of the DOM element, shape information 508 indicating a shape (e.g., rectangle, circle, square, etc.) of the DOM element, motion information 510 indicating motion parameters (e.g., playback speed, closed captioning information, etc.) for videos that may be represented as part of a DOM element, expression information 512 indicating an expression of a user's eyes (e.g., shrunk, dilated, etc.) and/or face while viewing the DOM element, state information 514 indicating the state of the user's eyes (e.g., open or closed) while viewing the DOM element, and time of gaze information 516 indicating how long the user's gaze dwelled on the DOM element. Any suitable additional or alternative information may be included as part of the data set shown in FIG. 5 as may serve a particular implementation.

Returning to FIG. 4, at operation 428, system 100 may use the information from the domain gaze dictionary generated at operation 426 to perform vector generation. The vector generation may include system 100 performing a clustering process at operation 430 that may include generating behavior vectors associated with the information in the domain gaze dictionary. The clustering process may be performed in any suitable manner. For example, system 100 may perform a K-means clustering process in which system 100 1) determines the number of clusters (K) and obtains the data points. Next system 100 May 2) place centroids c_1, c_2 . . . c_k randomly. For each data point x_i, system 100 May 3) find the nearest centroid (c_1, c_2 . . . c_k) and assign a point to that cluster. For each cluster j=1 . . . k, system 100 May 4) determine a new centroid as a mean of all points assigned to that cluster. System 100 may repeat operations 3) and 4) any suitable number of times until convergence is achieved or until a fixed number of iterations have been completed.

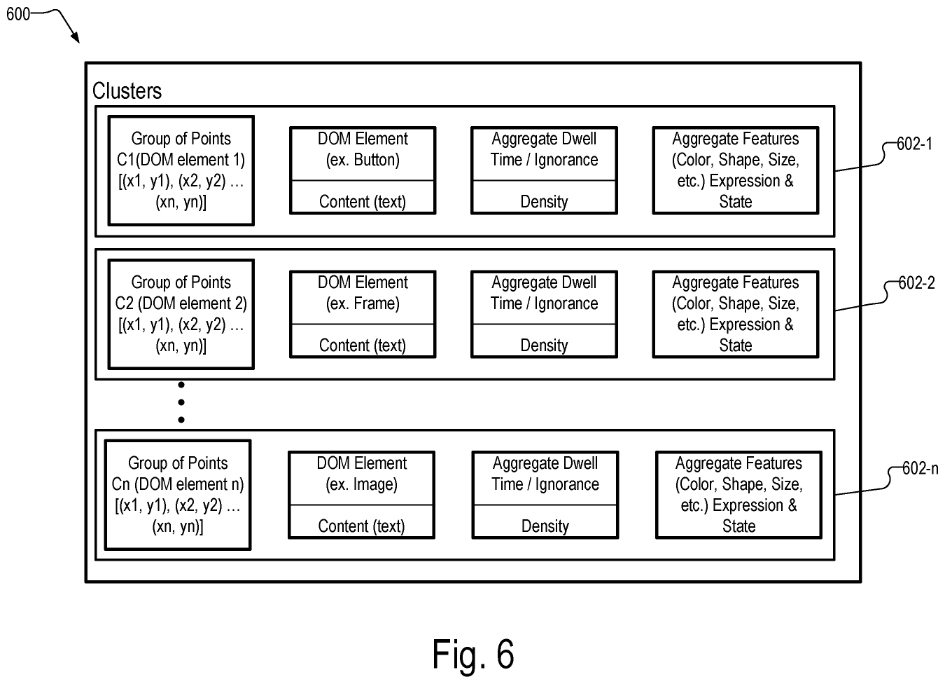

FIG. 6 depicts an illustrative diagram 600 showing information that may be included as part of clusters 602 (e.g., clusters 602-1 through 602-n) that may be generated during a clustering process. As shown in FIG. 6, cluster 602-1, for example, includes information identifying a group of gaze points C1 that may be associated with a DOM element represented in user interface content, DOM element information identifying the DOM element associated with the group of gaze points and providing content information for the DOM element, aggregate dwell time/ignorance information for the group of gaze points, aggregate features information (e.g., color, shape, size, etc.), expression information, and state information for the group of gaze points.

The aggregate dwell time for a DOM element may be determined in any suitable manner. For example, the aggregate dwell time may be determined based on the time of gaze of a first gaze point in the group of points and a time of gaze of a last point in the sequence for the same DOM element (provided all gaze points in between are gazed at the DOM element consecutively). In certain examples, the aggregate dwell time may include multiple sequences of dwell times for the same DOM element that occur at different time segments. For example, a user may gaze at a first DOM element for three seconds, a second DOM element for five seconds, and the first DOM element again for seven seconds. In such an example, system 100 may designate ten seconds as the aggregate dwell time for the first DOM element.

In certain examples, the aggregate dwell time in a cluster may include information indicative of a gaze density for the DOM element associated with the cluster. A gaze density may be indicative of a duration of gaze and/or may incorporate any suitable other aspects associated with a gaze such as gaze expression, biometric information, etc. In certain examples, a gaze density may correspond to a single numeric value that aggregates data associated with a plurality of different types of information included as part of engagement information. DOM elements/clusters with relatively lower gaze density may be indicative of the user ignoring content associated with those DOM elements/clusters. Whereas DOM elements/clusters with a relatively higher gaze density may be indicative of the user being more interested in content associated with those DOM elements/clusters.

In certain examples, the aggregate features, expression, and state information may provide a single aggregate value for a cluster. The single aggregate value may be computed in any suitable manner as may serve a particular implementation.

Returning to FIG. 4, the viewpoint calibration may further include system 100 performing a classifying operation at operation 430. The classifying operation may be performed in any suitable manner. For example, system 100 may perform a K-means classification to determine meaningful insights with respect to the clusters. Some meaningful insights may include, for example, rage views, content flow patterns, and/or design flow patterns. To illustrate an example, the combination of a user's pupils being dilated together with a high-density value may be indicative of a rage view. In such examples, system 100 may classify information associated with a user interface element based on a rage score. The rage score may be determined in any suitable manner. For example, a rage score may be determined based on the following expression: rage score=(if pupil dilated: weight=1, else weight=0)+density in DOM element. In certain examples, system 100 may further determine rage click segments, which may include a list of user interface elements with the same rage score. With a rage view classification, system 100 may sort the information in clusters by the rage view score to determine whether a user is interested or disinterested in user interface elements.

With content flow patterns, a sequence of gaze points across different user interface elements with similar content may be indicative of a user's interest/intent with respect to the user interface elements. In such examples, system 100 may group user interface elements with similar meaning/content in temporal order based on a sequence of gazes that the user viewed them. To illustrate an example, a webpage displayed by a browser may display different smartphones available for purchase by a user. A first user interface element may correspond to a picture of a new smartphone, a second user interface element may correspond to the price of the new smartphone, and a third user interface element may correspond to a user selectable button to initiate purchase of the new smartphone. In such an example, the user may sequentially gaze at the first user interface element, gaze at the second user interface element, and gaze at the third user interface element. Based on this sequence, system 100 may group the information associated with the first user interface element, the second user interface element, and the third user interface element as a content flow pattern with similar meaning content. System 100 may infer from such information that the user is interested in purchasing the new smart phone. In certain examples, such information may further be used by system 100 to determine whether the user completely consumed the webpage content/context, whether any elements were missed from the user's gaze (e.g., ignored elements), and/or for any other purpose.

With design flow patterns, a sequence of gaze points across different user interface elements with different content may be indicative of a user's interest/intent with respect to the user interface elements. To illustrate an example, when viewing a webpage displaying different smartphones available for purchase, a first user interface element may correspond to an image of a smartphone from a first manufacturer, a second user interface element may correspond to text describing a second smartphone from the first manufacturer, a third user interface element may correspond to an advertisement banner for a third smartphone from a second manufacturer, and a fourth user interface element may correspond to an add-to-cart button that may be selected by the user to save the third smartphone in a virtual shopping cart. In such an example, the user may sequentially gaze at the first user interface element, gaze at the second user interface element, gaze at the third user interface element, and gaze at the fourth user interface element. Based on this sequence, system 100 may group the information associated with the first user interface element, the second user interface element, the third user interface element, and the fourth user interface element as a design flow pattern with different meaning content. Such information may be used by system 100 to determine the attractiveness of each user interface element. For example, if the user gazed at the third user element corresponding to the advertisement banner with good density (e.g., for a long duration), system 100 may infer that the third smartphone from the second manufacturer is attractive to the user. On the other hand, if the user gazed at the second user interface element with a relatively lower density (e.g., for a relatively short duration), system 100 may infer that the user is not interested in the second smartphone from the first manufacturer.

In certain examples, system 100 may analyze patterns generated across multiple users to give insights on whether a particular user may be interested or disinterested in user interface content.

In certain examples, the classifying performed at operation 432 may result in a plurality of behavior vectors that may be used by system 100 to gain insights on the users' interest and/or disinterests with respect to user interface content.

At operation 434, system 100 may determine a behavior feature set based on the classifying performed at operation 432. To illustrate an example, if the classifying at operation 432 resulted in a relatively high rage score for a particular user interface element, system 100 may determine that the user is not interested in the content associated with the particular user interface element. On the other hand, if the classifying at operation 432 identifies a content flow pattern where a user repeatedly looks at a sequence of user interface elements, system 100 may determine that the user is interested in the content associated with the sequence of user interface elements. For example, in the new smartphone example described above, system 100 may determine that the user is interested in purchasing the new smartphone based on the content flow pattern of the user's gaze.

At operation 438, system 100 may generate and assign contextual cookies for use in tracking the user's intent with respect to user interface content. The contextual cookies may then be stored in any suitable manner (e.g., in the browser) and used for any suitable purpose to track user intents and/or user interests and provide content specifically tailored to the user.

At operation 440, system 100 may request consent to use contextual cookies across different domains and/or subdomains. With the consent, the sharing settings for the contextual cookies may be selected or updated such that different domains, sub domains, etc. may read and write the contextual cookies. In so doing, the contextual cookies may be used by different domains, sub domains, etc. without system 100 or a developer having to customize and/or update frontend code for generating cookies at each domain/subdomain. After selecting or updating the sharing settings, the contextual cookies may be exposed for use in any suitable manner.

In FIG. 6, operations 428 through 440 are shown as being implemented by a contextual cookie generator framework of system 100. The contextual cookie generator framework may be implemented in any suitable manner as may serve a particular implementation. It is understood that, in certain examples, a contextual cookie generator framework such as that shown in FIG. 6 may be implemented by a machine learning processor configured to execute any suitable machine learning algorithm(s) such as those described herein. In such examples, the inputs to the machine learning algorithm(s) may include any suitable information associated with a user's gaze of user interface content. For example, the inputs may include gaze duration, gaze location, DOM element information, biometric information, eye expression information, face expression information, and/or any other suitable information. Based on such information, the machine learning processor may generate behavior vectors, perform clustering, perform classification and prediction, and generate, as outputs to the machine learning algorithm(s), one or more contextual cookies in any suitable manner such as described herein.

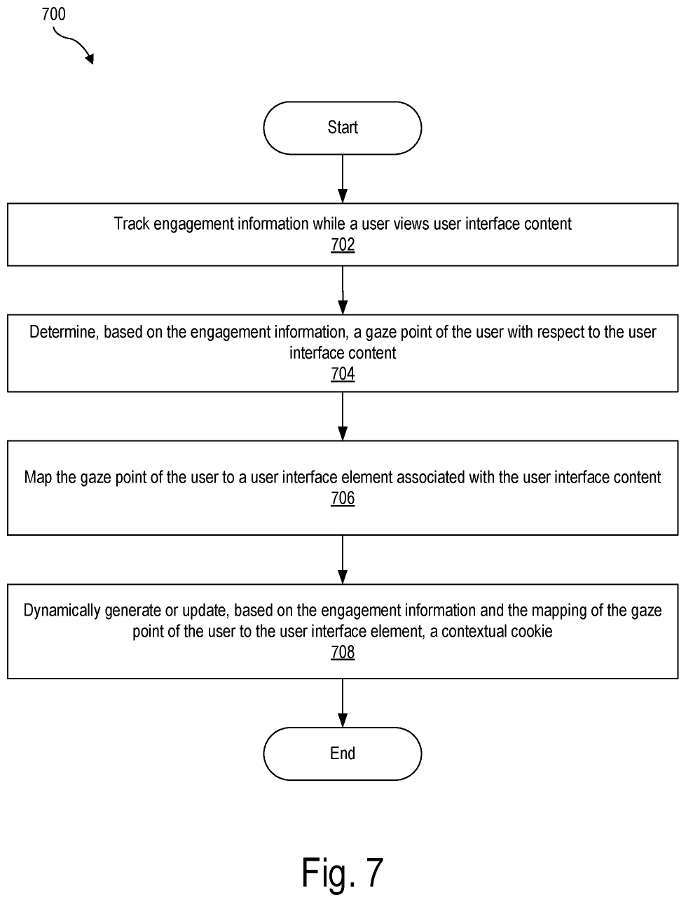

FIG. 7 depicts an illustrative method 700 for implementing contextual cookies. While FIG. 7 shows illustrative operations according to one embodiment, other embodiments may add to and/or modify the operations shown in FIG. 7. The operations shown in FIG. 7 may be performed by system 100, any components included therein, and/or any implementation thereof.

At operation 702, a system (e.g., contextual cookie management system 100) may track engagement information with a user views user interface content. Operation 702 may be performed in any of the ways described herein.

At operation 704, the system may determine, based on the engagement information, a gaze point of the user with respect to the user interface content. Operation 704 may be performed in any of the ways described herein.

At operation 706, the system may map the gaze point of the user to a user interface element associated with the user interface content. Operation 706 may be performed in any of the ways described herein.

At operation 708, the system may dynamically generate or update, based on the engagement information and the mapping of the gaze point of the user to the user interface element, a contextual cookie. Operation 708 may be performed in any of the ways described herein.

In some examples, a non-transitory computer-readable medium storing computer-readable instructions may be provided in accordance with the principles described herein. The instructions, when executed by a processor of a computing device, may direct the processor and/or computing device to perform one or more operations, including one or more of the operations described herein. Such instructions may be stored and/or transmitted using any of a variety of known computer-readable media.

A non-transitory computer-readable medium as referred to herein may include any non-transitory storage medium that participates in providing data (e.g., instructions) that may be read and/or executed by a computing device (e.g., by a processor of a computing device). For example, a non-transitory computer-readable medium may include, but is not limited to, any combination of non-volatile storage media and/or volatile storage media. Illustrative non-volatile storage media include, but are not limited to, read-only memory, flash memory, a solid-state drive, a magnetic storage device (e.g., a hard disk, a floppy disk, magnetic tape, etc.), ferroelectric random-access memory (RAM), and an optical disc (e.g., a compact disc, a digital video disc, a Blu-ray disc, etc.). Illustrative volatile storage media include, but are not limited to, RAM (e.g., dynamic RAM).

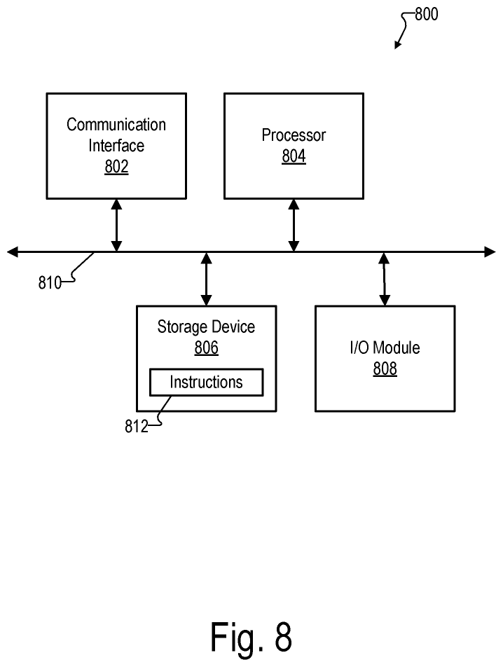

FIG. 8 shows an illustrative computing device 800 that may be specifically configured to perform one or more of the processes described herein. As shown in FIG. 8, computing device 800 may include a communication interface 802, a processor 804, a storage device 806, and an input/output (I/O) module 808 communicatively connected one to another via a communication infrastructure 810. While an illustrative computing device 800 is shown in FIG. 8, the components illustrated in FIG. 8 are not intended to be limiting. Additional or alternative components may be used in other embodiments. Components of computing device 800 shown in FIG. 8 will now be described in additional detail.

Communication interface 802 may be configured to communicate with one or more computing devices. Examples of communication interface 802 include, without limitation, a wired network interface (such as a network interface card), a wireless network interface (such as a wireless network interface card), a modem, an audio/video connection, and any other suitable interface.

Processor 804 generally represents any type or form of processing unit (e.g., one or more physical computer processors) capable of processing data and/or interpreting, executing, and/or directing execution of one or more of the instructions, processes, and/or operations described herein. Processor 804 may perform operations by executing computer-executable instructions 812 (e.g., an application, software, code, and/or other executable data instance) stored in storage device 806.

Storage device 806 may include one or more data storage media, devices, or configurations and may employ any type, form, and combination of data storage media and/or device. For example, storage device 806 may include, but is not limited to, any combination of the non-volatile media and/or volatile media described herein. Electronic data, including data described herein, may be temporarily and/or permanently stored in storage device 806. For example, data representative of computer-executable instructions 812 configured to direct processor 804 to perform any of the operations described herein may be stored within storage device 806. In some examples, data may be arranged in one or more location databases residing within storage device 806.

I/O module 808 may include one or more I/O modules configured to receive user input and provide user output. One or more I/O modules may be used to receive input for a virtual experience. I/O module 808 may include any hardware, firmware, software, or combination thereof supportive of input and output capabilities. For example, I/O module 808 may include hardware and/or software for capturing user input, including, but not limited to, a keyboard or keypad, a touchscreen component (e.g., touchscreen display), a receiver (e.g., an RF or infrared receiver), motion sensors, and/or one or more input buttons.

I/O module 808 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O module 808 is configured to provide graphical data to a display for presentation to a user. The graphical data may be representative of one or more graphical user interfaces and/or any other graphical content as may serve a particular implementation.

In some examples, any of the systems, computing devices, and/or other components described herein may be implemented by computing device 800. For example, memory 102 may be implemented by storage device 806, and processor 104 may be implemented by processor 804.

To the extent the aforementioned embodiments collect, store, and/or employ personal information provided by individuals, it should be understood that such information shall be used in accordance with all applicable laws concerning protection of personal information. Additionally, the collection, storage, and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information.

In the preceding description, various illustrative embodiments have been described with reference to the accompanying drawings. It will, however, be evident that various modifications and changes may be made thereto, and additional embodiments may be implemented, without departing from the scope of the invention as set forth in the claims that follow. For example, certain features of one embodiment described herein may be combined with or substituted for features of another embodiment described herein. The description and drawings are accordingly to be regarded in an illustrative rather than a restrictive sense.

What is claimed is:

1. A system comprising:
a memory that stores instructions; and
a processor communicatively coupled to the memory and configured to execute the instructions to perform a process comprising:
tracking engagement information of a user while the user views user interface content;
determining, based on the engagement information, a gaze point of the user with respect to the user interface content;
mapping the gaze point of the user to a user interface element associated with the user interface content; and
dynamically generating or updating, based on the engagement information and the mapping of the gaze point of the user to the user interface element, a contextual cookie that is configured to store user intent information associated with the user's engagement with the user interface content.

2. The system of claim 1, wherein the contextual cookie is configured to be used across different domains and different subdomains to track engagement of the user with respect to different user interface content.

3. The system of claim 1, wherein the tracking of the engagement information includes:
accessing image data captured by an imaging device positioned in front of the user; and
processing the image data to identify at least some of the engagement information.

4. The system of claim 1, wherein the engagement information includes biometric information including eye gaze position information indicative of where the user is looking with respect to the user interface content.

5. The system of claim 4, wherein the biometric information further includes at least one of eye attribute information, heart rate information, or facial expression information.

6. The system of claim 1, wherein the mapping of the gaze point of the user to the user interface element includes:
accessing a domain tree structure of the user interface content that includes information indicating a position and one or more attributes of the user interface element associated with the user interface content; and
determining, based on the domain tree structure, that the gaze point of the user is at a position that corresponds to the user interface element.

7. The system of claim 1, wherein the dynamically generating or updating of the contextual cookie includes:
determining, based on the engagement information, an intent of the user with respect to the user interface element; and
storing the intent of the user as part of the user intent information of the contextual cookie.

8. The system of claim 1, wherein the dynamically generating or updating of the contextual cookie includes:
generating a plurality of behavior vectors based on the engagement information;
clustering the plurality of behavior vectors into a plurality of clusters;
classifying the plurality of clusters;
predicting, based on the classifying of the plurality of clusters, an intent of the user with respect to the user interface element; and
storing the intent of the user as part of the user intent information of the contextual cookie.

9. The system of claim 1, wherein the dynamically generating or updating of the contextual cookie includes executing a machine learning algorithm to process the engagement information.

10. The system of claim 1, wherein the user intent information of the contextual cookie includes:
a first name-value pair that includes information indicating an intent of the user with respect to the user interface element; and
a second name-value pair that includes information indicating an ignored portion of the interface content.

11. The system of claim 1, wherein the process further comprises:
determining, based on the engagement information, an additional gaze point of the user with respect to the user interface content;
mapping the additional gaze point of the user to an additional user interface element associated with the user interface content; and
determining, based on the mapping of the additional gaze point to the additional user interface element, an engagement sequence of the user with respect to the user interface element and the additional user interface element,
wherein the dynamically generating or updating of the contextual cookie includes determining, based on the engagement sequence, an intent of the user with respect to the user interface element and the additional user interface element.

12. A non-transitory computer readable storage medium, comprising instructions that when executed by a processor cause the processor to:
track engagement information of a user while the user views user interface content;
determine, based on the engagement information, a gaze point of the user with respect to the user interface content;
map the gaze point of the user to a user interface element associated with the user interface content; and
dynamically generate or update, based on the engagement information and the mapping of the gaze point of the user to the user interface element, a contextual cookie that is configured to store user intent information associated with the user's engagement with the user interface content.

13. The storage medium of claim 12, wherein the contextual cookie is configured to be used across different domains and different subdomains to track engagement of the user with respect to different user interface content.

14. The storage medium of claim 12, wherein the determining of the gaze point of the user with respect to the user interface element includes:
accessing a domain tree structure of the user interface content that includes information indicating a position and one or more attributes of the user interface element within the user interface content; and
determining, based on the domain tree structure, that the gaze point of the user is at a position that corresponds to the user interface element.

15. The storage medium of claim 12, wherein the dynamically generating or updating of the contextual cookie includes:
determining, based on the engagement information, an intent of the user with respect to the user interface element; and
storing the intent of the user as part of the user intent information of the contextual cookie.

16. A method comprising:
tracking, by a contextual cookie management system, engagement information of a user while the user views user interface content;
determining, by the contextual cookie management system and based on the engagement information, a gaze point of the user with respect to the user interface content;
mapping, by the contextual cookie management system, the gaze point of the user to a user interface element associated with the user interface content; and
dynamically generating or updating, by the contextual cookie management system and based on the engagement information and the mapping of the gaze point of the user to the user interface element, a contextual cookie that is configured to store user intent information associated with the user's engagement with the user interface content.

17. The method of claim 16, further comprising:
determining, based on the engagement information, an additional gaze point of the user with respect to the user interface content;
mapping the additional gaze point of the user to an additional user interface element associated with the user interface content; and
determining, based on the mapping of the additional gaze point to the additional user interface element, an engagement sequence of the user with respect to the user interface element and the additional user interface element,
wherein the dynamically generating or updating of the contextual cookie includes determining, based on the engagement sequence, an intent of the user with respect to the user interface element and the additional user interface element.

18. The method of claim 16, wherein the contextual cookie is configured to be used across different domains and different subdomains to track engagement of the user with respect to different user interface content.

19. The method of claim 16, wherein the mapping of the gaze point of the user to the user interface element includes:
accessing a domain tree structure of the user interface content that includes information indicating a position and one or more attributes of the user interface element within the user interface content; and
determining, based on the domain tree structure, that the gaze point of the user is at a position that corresponds to the user interface element.

20. The method of claim 16, wherein the dynamically generating or updating of the contextual cookie includes:
generating a plurality of behavior vectors based on the engagement information;
clustering the plurality of behavior vectors into a plurality of clusters;
classifying the plurality of clusters;
predicting, based on the classifying of the plurality of clusters, an intent of the user with respect to the user interface element; and
storing the intent of the user as part of the user intent information of the contextual cookie.
